(19) United States
(12) Patent Application Publication
(10) Pub. No.: US 2012/0170261 A1
(43) Pub. Date: Jul. 5, 2012

(54) LIGHT SOURCE MODULE

(76) Inventors: Chih-Ming Hu, Hsinchu City (TW); Chia-Hao Chang, Hsinchu City (TW)

(21) Appl. No.: 13/329,779

(22) Filed: Dec. 19, 2011

(30) Foreign Application Priority Data
Jan. 4, 2011 (TW) 100100121

(51) Int. Cl. F21V 21/00

(52) U.S. Cl. 362/217.16; 362/217.14

(57) ABSTRACT

A light source module includes a base, a positioning member, a LED light bar having a first electrical contact, and a circuit board having a second electrical contact. The positioning member is mounted on the base and has a first slot and a second slot. The LED light bar is inserted into the first slot and capable of being extracted from the first slot. The circuit board is inserted into the second slot and capable of being extracted from the second slot. The LED light bar is electrically connected to the circuit board via the first electrical contact and the second electrical contact when the LED light bar and the circuit board are respectively inserted into the first slot and the second slot.

### BACKGROUND OF THE INVENTION

a. Field of the Invention

The invention relates to a light source module.

b. Description of the Related Art

Referring to FIG. 1, a light source module 100 includes a heat-dissipating plate 102, a metal core printed circuit board (MCPCB) 104, and a plurality of light-emitting diodes (LEDs) 106. The MCPCB 104 includes an aluminum substrate 104a and an insulation layer 104b, a copper foil layer 104c, and a solder mask layer 104d formed on the aluminum substrate 104a. The insulation layer 104b is used to prevent the upper aluminum substrate 104a from being electrically connected with the lower copper foil layer 104c. The copper foil layer 104c is etched to form a circuit for the light-emitting diodes 106, and the solder mask layer 104d is used to avoid electrical conduction due to external contact. The aluminum substrate 104a has good thermal conductivity and may quickly transfer the heat generated by the light-emitting diodes 106 to the heat-dissipating plate 102. However, according to the above design, when the number of the light-emitting diodes 106 is to be changed or a different type of the light-emitting diodes 106 is to be used, the light-emitting diodes 106 on the old MCPCB 104 are removed and substituted light-emitting diodes 106 are soldered to a new MCPCB 104 having corresponding circuit structures. The entire replacement procedure is time-consuming. Besides, if the input specification of a DC power source is changed, the circuit layout of the light-emitting diodes 106 of the MCPCB 104 needs to be changed, and thus the old MCPCB 104 is no longer used. Further, when the circuit layout for the light-emitting diodes 106 is complicate, a multi-layer MCPCB 104 is often required. However, the heat dissipation capability of the multi-layer MCPCB 104 is lower compared with a single-layer MCPCB 104, and thus the heat generated by the light-emitting diodes 106 are not sufficiently dissipated to the heat-dissipating plate 102 to reduce the luminance efficiency of the light-emitting diodes 106. Further, when the light-emitting diodes 106 have defects or are damaged by human or external factors, the entire MCPCB 104 needs to be removed for repair, and the damaged light-emitting diodes 106 are taken off and replaced. This is very time-consuming, and consumers fail to repair or replace damaged light-emitting diodes by themselves.

In other conventional design, for example, Taiwan patent publication no. 200846776 discloses a side-emission type light source module having an L-shaped heat conducting bracket, a metal core printed circuit board (MCPCB), and a light-emitting diode (LED). The MCPCB is disposed on the L-shaped heat conducting bracket, and the LED is mounted on the MCPCB by a bottom surface. The MCPCB is placed flat on the side-emission type light source module to increase the routing area of the surface of the MCPCB and to decrease the thickness of the side-emission type light source module. Further, US patent publication no. 20090185393 discloses a light source module having a substrate, a plurality of LEDs, and a holder. The substrate includes a base plate, a protection plate and metal lines, and the holder includes a protection cover and connecting electrodes. The electrodes of the LED are connected to the metal lines of the substrate via the connecting electrodes of the holder. Besides, Taiwan patent publication no. 200835967 discloses an L-shaped heat conducting structure to increase the number of heat dissipation paths. Further, Taiwan patent no. M288384 discloses a heat-dissipating device, and Taiwan patent no. M315841 discloses a replaceable LED light source.

### BRIEF SUMMARY OF THE INVENTION

The invention provides a light source module having at least one advantages of simplified detachment, convenient replacement, low fabrication costs, reduced thickness, and low heat dissipation requirement.

Other objects and advantages of the invention may be further illustrated by the technical features broadly embodied and described as follows.

In order to achieve one or part of or all of the above merits, an embodiment of the invention provides a light source module including a base, a positioning member, a light-emitting diode (LED) light bar, and a circuit board. The base has a first part and a second part forming an angle with the first part. The positioning member is placed against the first part and the second part of the base and includes a first slot near the first part and a second slot near the second part. The LED light bar is disposed in the first slot to be positioned on the first part of the base and capable of being extracted from the first slot. The LED light bar has a carrier board and a plurality of light-emitting diodes disposed on the carrier board, and the carrier board includes a first electrical contact. The circuit board is disposed in the second slot to be positioned on the second part of the base and capable of being extracted from the second slot, and the circuit board has a second electrical contact. When the LED light bar is inserted into the first slot and the circuit board is inserted into the second slot, the LED light bar is electrically connected to the circuit board via the first electrical contact and the second electrical contact.

In one embodiment, the first slot of the positioning member has a first conductive side wall, the second slot of the positioning member has a second conductive side wall, and the first conductive side wall is connected to the second conductive side wall. In addition, the positioning member may further include a first conductive elastic sheet and a second conductive elastic sheet. The first conductive elastic sheet is connected to the first conductive side wall and the second conductive elastic sheet is connected to the second conductive side wall. When the LED light bar is inserted into the first slot, the first electrical contact is in contact with the first conductive elastic sheet. When the circuit board is inserted into the second slot, the second electrical contact is in contact with the second conductive elastic sheet.

In one embodiment, the first slot is substantially parallel to the first part of the base and the second slot is substantially parallel to the second part of the base.

In one embodiment, the light source module further includes a plurality of mounting members to fix the LED light bar and the circuit board on the base.

In one embodiment, the positioning member is an electrical conductor, the first electrical contact is in contact with the positioning member when the LED light bar is inserted into the first slot, and the second electrical contact is in contact with the positioning member when the circuit board is inserted into the second slot.

In one embodiment, the light source module further includes a programmable control chip or a sub circuit board disposed on the circuit board.

Another embodiment of the invention provides a light source module, and the light source module includes a base, a light-emitting diode light bar, and a circuit board. The base has a first part and a second part forming an angle with the first part. The LED light bar is disposed on the first part of the base and capable of being extracted from the first part. The LED light bar includes a carrier board and a plurality of light-emitting diodes. The carrier board includes a first connector and the light-emitting diodes (LEDs) are disposed on the carrier board. The circuit board has a second connector. The first connector and the second connector are fitted to each other so that the LED light bar is positioned on the first part of the base, the circuit board is positioned on the second part of the base, and the LED light bar is electrically connected to the circuit board.

In one embodiment, the light source module further includes a bus line set connected between the first connector and the second connector.

The embodiment or the embodiments of the invention may have at least one of the following advantages.

According to the above embodiments, the LED light bar and the circuit board are separate from each other and both are replaceable. Therefore, when the circuit layout of the circuit board is to be changed to fit a different circuit design or some components in the circuit need to be repaired, only the old circuit board is needed to be extracted for maintenance or replaced with a new circuit board without moving the LED light bar. In comparison, if damaged LEDs need to be repaired, only the LED light bar needs to be extracted to replace the LEDs without moving the circuit board. Moreover, according to the conventional design, a metal core printed circuit board having complex interconnection is often used as a carrier board for LEDs, so the carrier board may occupy a large area. On the contrary, according to the embodiments of the invention, the carrier board of the LED light bar and the circuit board are separate from each other. Therefore, the carrier board for LEDs only needs the wiring to connect to the positioning member to thereby reduce the occupied space and thickness of the carrier board and decrease fabrication costs. Further, the heat generated by the LEDs is quickly conducted to the base through the thinner carrier board to increase the heat dissipation efficiency. Besides, since the circuit board is not disposed on the heat dissipation path from the LEDs to the base, an expensive metal core printed circuit board (MCPCB) having full heat dissipation capability is no longer needed. Therefore, only a low-cost circuit board such as an FR4 glass fiber circuit board is required to further reduce fabrication costs.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional light source module.

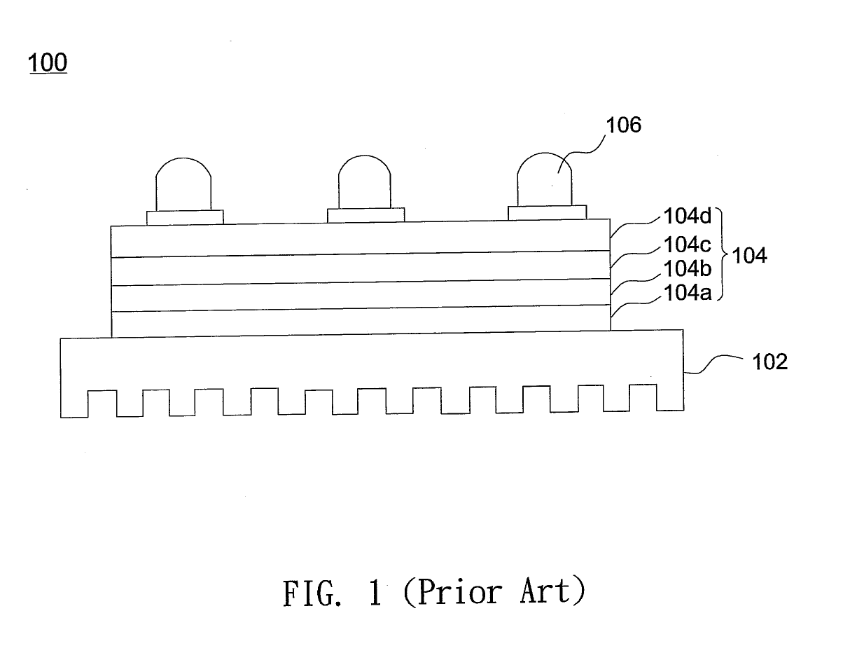

FIG. 2 shows an exploded diagram of a light source module according to an embodiment of the invention.

FIG. 3 shows a three-dimensional schematic diagram of an assembled light source module shown in FIG. 2.

FIGS. 4A and 4B show schematic diagrams illustrating the effect of reducing the space occupied by a carrier board according to an embodiment of the invention.

FIG. 5 shows an exploded diagram of a light source module according to another embodiment of the invention.

FIG. 6 shows a three-dimensional schematic diagram of an assembled light source module shown in FIG. 5.

FIG. 7 shows a schematic diagram of a light source module according to another embodiment of the invention.

FIG. 8 shows a schematic diagram of a light source module according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

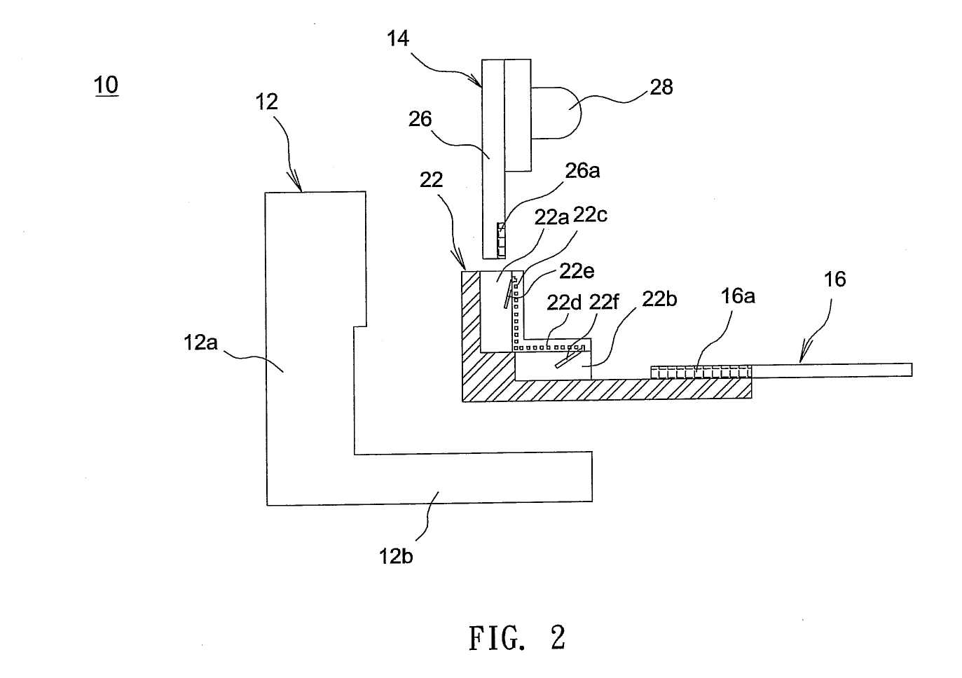

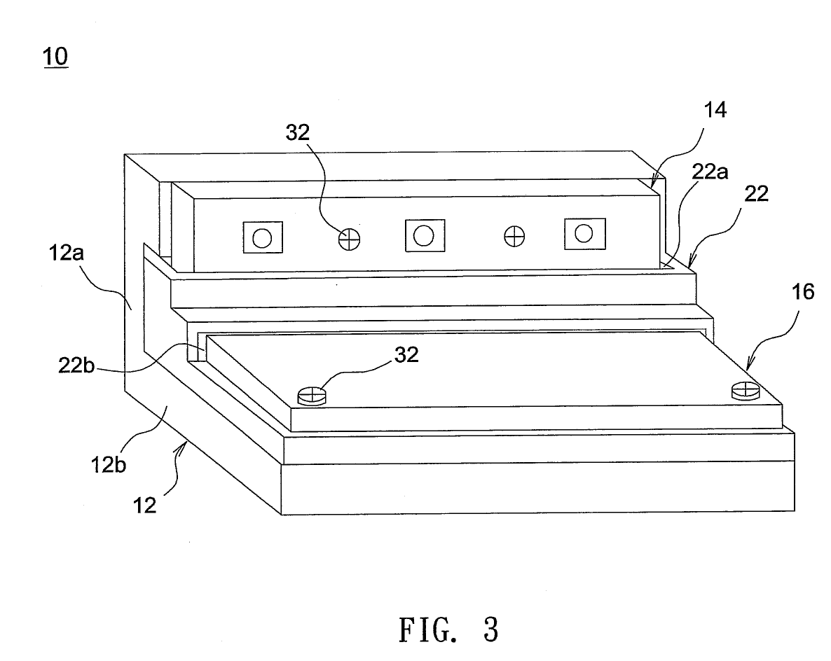

Please refer to both FIG. 2 and FIG. 3, a light source module 10 according to one embodiment of the invention includes a base 12, a light-emitting diode (LED) light bar 14, a circuit board 16, and a positioning member 22. The base 12 has a first part 12a and a second part 12b forming an angle with the first part 12a. The base 12 may include a material with high thermal conductivity to function as a heat sink. For example, the first part 12a and the second part 12b may be perpendicular to each other. In this embodiment, the positioning member 22 is placed against the first part 12a and the second part 12b of the base 12, and the positioning member 22 includes a first slot 22a near the first part 12a and a second slot 22b near the second part 12b. The first slot 22a forms an angle with the second slot 22b. For example, the first slot 22a and the second slot 22b are perpendicular to each other. The first slot 22a is substantially parallel to the first part 12a of the base 12, and the second slot 22b is substantially parallel to the second part 12b of the base 12. Part of the side wall of the first slot 22a is made of a conductive material to form a conductive side wall 22c, part of the side wall of the second slot 22b is made of a conductive material to form a conductive side wall 22d, and the conductive side wall 22c is connected with the conductive side wall 22d. A first conductive elastic sheet 22e is connected to the conductive side wall 22c of the first slot 22a, and a second conductive elastic sheet 22f is connected to the conductive side wall 22d of the second slot 22b. The LED light bar 14 includes a carrier board 26 and a plurality of light-emitting diodes 28 disposed on the carrier board 26. The carrier board 26 includes an electrical contact 26a. During assembly, the positioning member 22 is placed on the base 12 and touches the first part 12a and the second part 12b of the base 12, the LED light bar 14 is inserted into the first slot 22a, and the electrical contact 26a of the LED light bar 14 is in contact with the first conductive elastic sheet 22e. The circuit board 16 is inserted into the second slot 22b, and an electrical contact 16a of the circuit board 16 is in contact with the second conductive elastic sheet 22f. Therefore, the electrical contacts 16a and 26a, the conductive elastic sheets 22e and 22f, and the conductive side walls 22c and 22d together form a conduction pathway to allow the LED light bar 14 to be electrically connected to the circuit board 16. As shown in FIG. 3, in the assembled light source module 10, the LED light bar 14 is inserted into the first slot 22a to be positioned on the first part 12a of the base 12, and the LED light bar 14 is capable of being extracted from the first slot 22a. The circuit board 16 is inserted into the second slot 22b to be positioned on the second part 12b of the base 12, and the circuit board 16 is capable of being extracted from the second slot 22b. The LED light bar 14 and the circuit board 16 may be fixed on the base 12 by a positioning member such as a screw 32. Certainly, the method for electrically connecting the LED light bar 14 with the circuit board 16 is not restricted. In an alternate embodiment, the positioning member 22 is an electrical conductor. When the LED light bar 14 is inserted into the first slot 22a and the circuit board 16 is inserted into the second slot 22b, the electrical contact 26a of the LED light bar 14 and the electrical contact 16a of the circuit board 16 are separately in contact with the positioning member 22 to realize electrical connection. Therefore, the conductive elastic sheets 22e and 22f may be omitted.

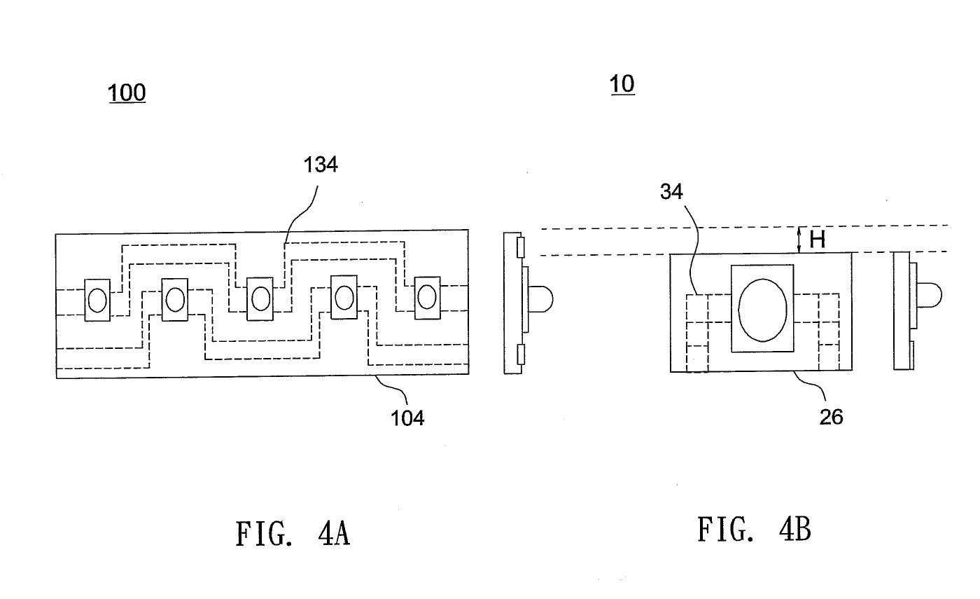

According to the design of the above embodiments, the LED light bar 14 and the circuit board 16 are separate from each other and both are replaceable. Therefore, when the circuit layout of the circuit board 16 is to be changed to fit a different circuit design or some components in the circuit need to be repaired, only the old circuit board 16 is needed to be extracted for maintenance or replaced with a new circuit board 16 without moving the LED light bar 14. In comparison, if damaged LEDs 28 need to be repaired, only the LED light bar 14 needs to be extracted to replace the LEDs 28 without moving the circuit board 16. Moreover, as shown in FIG. 4A, according to the conventional design, a metal core printed circuit board (MCPCB) 104 having complex interconnection 134 (dashed lines shown in FIG. 4A) is often used as a carrier board for LEDs, so the carrier board may occupy a large area. On the contrary, as shown in FIG. 4B, according to the embodiments of the invention, the carrier board 26 of the LED light bar 14 and the circuit board 16 are separate from each other. Therefore, the carrier board 26 for LEDs only needs the wiring 34 (dashed lines shown in FIG. 4B) to connect to the positioning member 22 to thereby reduce the occupied space and thickness of the carrier board 26 and decrease fabrication costs. As a result, the entire thickness of the light source module 10 is reduced. Specifically, compared with the conventional design shown in FIG. 4A and the embodiment of the invention shown in FIG. 4B, the carrier board according to the embodiment of the invention has a reduced space H, and the heat generated by the LEDs 28 is quickly conducted to the base 12 through the thinner carrier board 26 to increase the heat dissipation efficiency. Besides, since the circuit board 16 is not disposed on the heat dissipation path from the LEDs 28 to the base 12, an expensive metal core printed circuit board (MCPCB) having full heat dissipation capability is no longer needed. Therefore, only a low-cost circuit board such as an FR4 glass fiber circuit board is required to further reduce fabrication costs.

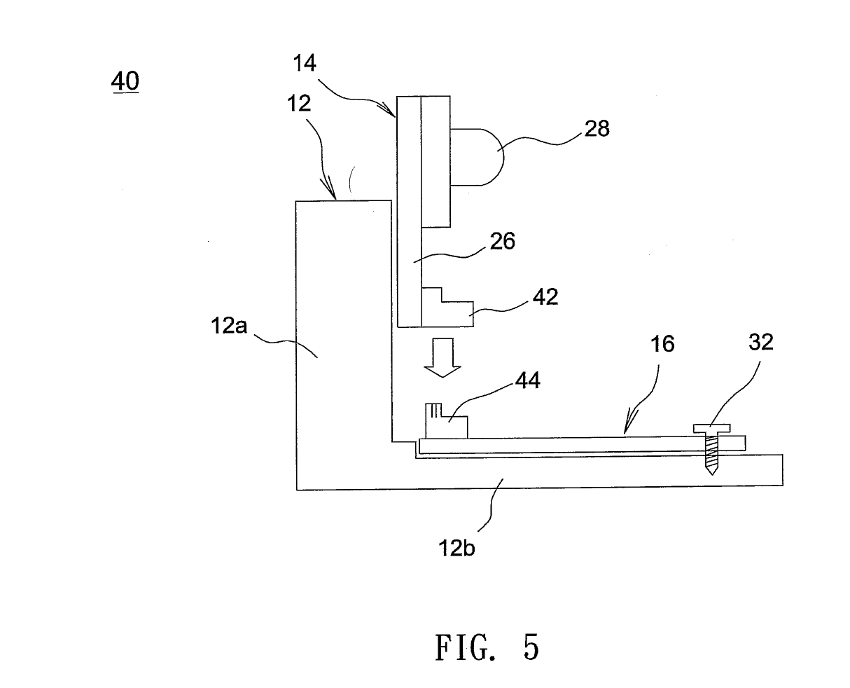

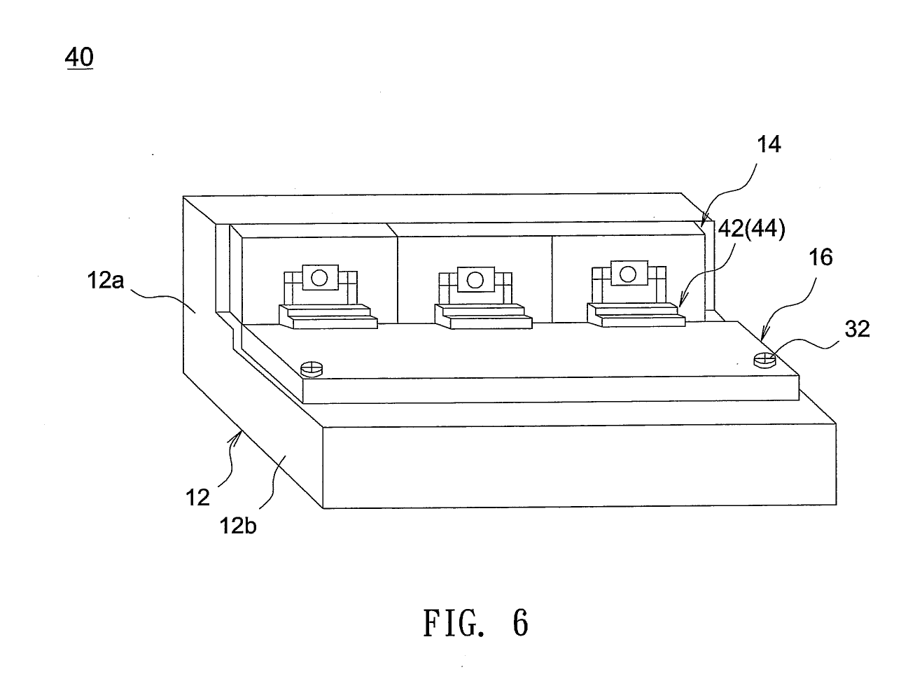

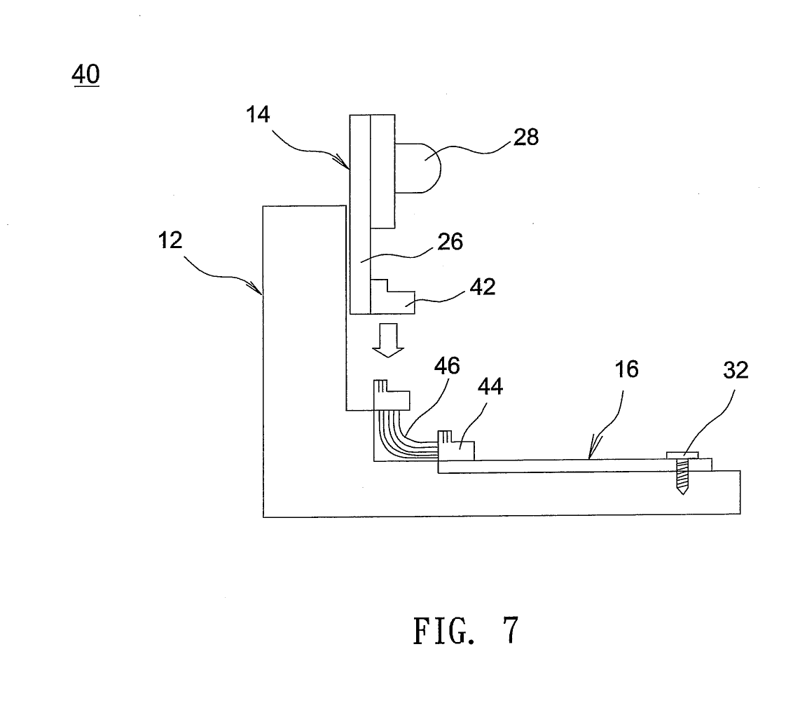

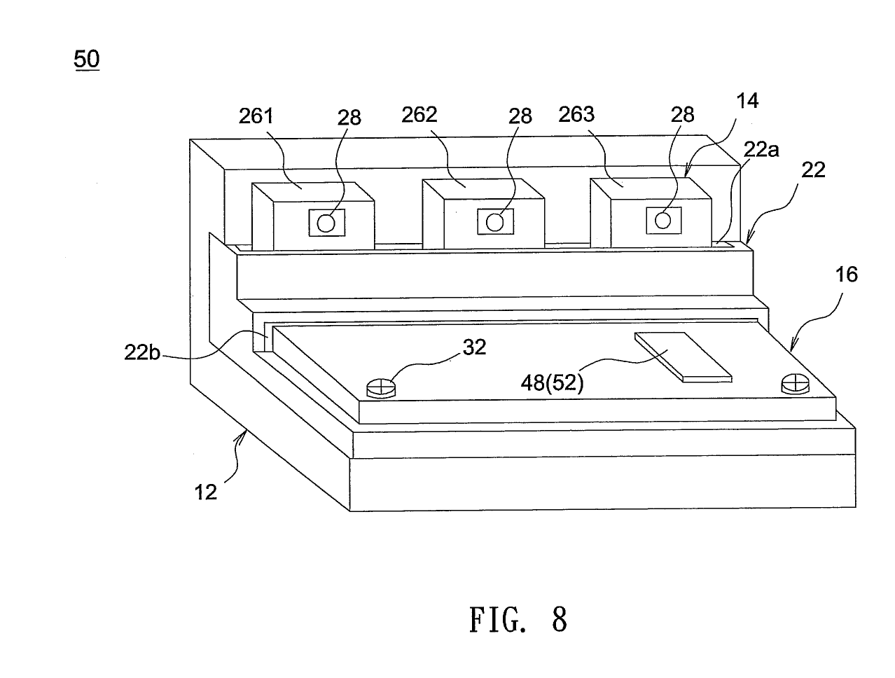

Please refer to both FIG. 5 and FIG. 6, in this embodiment, a first connector 42 is disposed on one end of the carrier board 26, and a second connector 44 is disposed on one end of the circuit board 16. The first connector 42 and the second connector 44 are fitted to each other. For example, the first connector 42 and the second connector 44 may be male and female connectors. When the first connector 42 is inserted into the second connector 44, the LED light bar 14 is positioned on the first part 12a of the base 12 and the circuit board 16 is positioned on the second part 12b of the base 12, and the LED light bar 14 is electrically connected to the circuit board 16. The circuit board 16 may be fixed on the base 12 by a positioning member such as a screw 32. Further, as shown in FIG. 7, the light source module 40 may further include a bus line set 46 connected between the first connector 42 and the second connector 44. By varying the length of the bus line set 46, the position or size of the circuit board 16 may be adjusted. In an alternate embodiment shown in FIG. 8, the light source module 50 uses a plurality of carrier blocks 261, 262 and 263 separate from each other instead of a one-piece carrier board 26 to separately hold a LED 28. Thus, less material amount of the carrier board is used to further decrease fabrication costs. Further, as shown in FIG. 8, each LED 28 is separately disposed on one of the separate carrier blocks 261-263. Therefore, if one of the LEDs 28 is damaged, only one carrier block needs to be extracted. For example, in case the LED 28 on the carrier block 262 is to be replaced, only the carrier block 262 needs to be extracted to replace the LED 28. Therefore, the convenience in replacing a LED 28 is further improved. Note the design of separate carrier blocks 261-263 may be also used in the embodiments shown in FIGS. 3, 6 and 7 to similarly decrease fabrication costs and enhance the convenience of replacing an LED. Besides, in the previous embodiments, a programmable control chip 48 (such as a constant-current IC) or a sub circuit board 52 may be disposed on the circuit board 16 to provide additional functions according to actual demands.

The embodiment or the embodiments of the invention may have at least one of the following advantages.

According to the above embodiments, the LED light bar and the circuit board are separate from each other and both are replaceable. Therefore, when the circuit layout of the circuit board is to be changed to fit a different circuit design or some components in the circuit need to be repaired, only the old circuit board is needed to be extracted for maintenance or replaced with a new circuit board without moving the LED light bar. In comparison, if damaged LEDs need to be repaired, only the LED light bar needs to be extracted to replace the LEDs without moving the circuit board. Moreover, according to the conventional design, a metal core printed circuit board having complex interconnection is often used as a carrier board for LEDs, so the carrier board may occupy a large area. On the contrary, according to the embodiments of the invention, the carrier board of the LED light bar and the circuit board are separate from each other. Therefore, the carrier board for LEDs only needs the wiring to connect to the positioning member to thereby reduce the occupied space and thickness of the carrier board and decrease fabrication costs. Further, the heat generated by the LEDs is quickly conducted to the base through the thinner carrier board to increase the heat dissipation efficiency. Besides, since the circuit board is not disposed on the heat dissipation path from the LEDs to the base, an expensive metal core printed circuit board (MCPCB) having full heat dissipation capability is no longer needed. Therefore, only a low-cost circuit board such as an FR4 glass fiber circuit board is required to further reduce fabrication costs.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A light source module, comprising:
a base, having a first part and a second part forming an angle with the first part;
a positioning member, placed against the first part and the second part of the base and comprising a first slot near the first part and a second slot near the second part;
a light-emitting diode light bar, disposed in the first slot to be positioned on the first part of the base and capable of being extracted from the first slot, wherein the light-emitting diode light bar comprises a carrier board and a plurality of light-emitting diodes disposed on the carrier board, and the carrier board comprises a first electrical contact; and
a circuit board, disposed in the second slot to be positioned on the second part of the base and capable of being extracted from the second slot, wherein the circuit board comprises a second electrical contact, and the light-emitting diode light bar is electrically connected to the circuit board via the first electrical contact and the second electrical contact when the light-emitting diode light bar and the circuit board are respectively inserted into the first slot and the second slot.

2. The light source module as claimed in claim 1, wherein the first slot of the positioning member has a first conductive side wall, the second slot of the positioning member has a second conductive side wall, and the first conductive side wall is connected to the second conductive side wall.

3. The light source module as claimed in claim 2, wherein the positioning member further comprises:
a first conductive elastic sheet, connected to the first conductive side wall; and
a second conductive elastic sheet, connected to the second conductive side wall, wherein the first electrical contact is in contact with the first conductive elastic sheet when the light-emitting diode light bar is inserted into the first slot, and the second electrical contact is in contact with the second conductive elastic sheet when the circuit board is inserted into the second slot.

4. The light source module as claimed in claim 1, wherein the first slot is substantially parallel to the first part of the base and the second slot is substantially parallel to the second part of the base.

5. The light source module as claimed in claim 1, further comprising:
a plurality of mounting members to fix the light-emitting diode light bar and the circuit board on the base.

6. The light source module as claimed in claim 1, wherein the positioning member is an electrical conductor, the first electrical contact is in contact with the positioning member when the light-emitting diode light bar is inserted into the first slot, and the second electrical contact is in contact with the positioning member when the circuit board is inserted into the second slot.

7. The light source module as claimed in claim 6, wherein the first slot is substantially parallel to the first part of the base, and the second slot is substantially parallel to the second part of the base.

8. The light source module as claimed in claim 1, further comprising:
a programmable control chip or a sub circuit board disposed on the circuit board.

9. The light source module as claimed in claim 1, wherein the base comprises a material with high thermal conductivity.

10. The light source module as claimed in claim 1, wherein the carrier board comprises a plurality of carrier blocks separate from each other.

11. The light source module as claimed in claim 10, wherein each of the light-emitting diodes is separately disposed on one of the carrier blocks.

12. A light source module, comprising:
a base, having a first part and a second part forming an angle with the first part;
a light-emitting diode light bar, disposed on the first part and capable of being extracted from the first part, wherein the LED light bar comprises:
a carrier board having a first connector; and
a plurality of light-emitting diodes disposed on the carrier board; and
a circuit board, having a second connector, wherein the first connector and the second connector are fitted to each other so that the light-emitting diode light bar is positioned on the first part of the base, the circuit board is positioned on the second part of the base, and the light-emitting diode light bar is electrically connected to the circuit board.

13. The light source module as claimed in claim 12, further comprising:
a bus line set, connected between the first connector and the second connector.

14. The light source module as claimed in claim 12, further comprising:
a plurality of mounting members to fix the circuit board on the base.

15. The light source module as claimed in claim 12, further comprising:
a programmable control chip or a sub circuit board disposed on the circuit board.

16. The light source module as claimed in claim 12, wherein the base comprises a material with high thermal conductivity.

17. The light source module as claimed in claim 12, wherein the carrier board comprises a plurality of carrier blocks separate from each other.

18. The light source module as claimed in claim 17, wherein each of the light-emitting diodes is separately disposed on one of the carrier blocks.
